(19) United States
(12) Patent Application Publication
(10) Pub. No.: US 2014/0374454 A1
(43) Pub. Date: Dec. 25, 2014

(54) RECEIVING SYSTEM FOR A SAFETY VEST UNIT IN A VEHICLE INTERIOR

(71) Applicant: Markus HINTENNACH, Baltmannsweiler (DE)

(72) Inventor: Markus HINTENNACH, Baltmannsweiler (DE)

(21) Appl. No.: 14/311,973

(22) Filed: Jun. 23, 2014

(30) Foreign Application Priority Data
Jun. 24, 2013 (DE) 10 2013 211 965.8

(51) Int. Cl. B60R 7/04; B65D 85/18

(52) U.S. Cl. CPC B60R 7/04; B65D 85/18
USPC 224/539; 206/278

(57) ABSTRACT

A safety vest unit is disclosed having at least one compactly packed safety vest and also having a packaging of a thin flexible fabric that encompasses the at least one safety vest.

In accordance with the invention, the packaging that encompasses the safety vest is embodied as vacuum packaging.

Installation in the case of a passenger car.

### CROSS REFERENCE TO RELATED APPLICATION

This application claims the priority of the German patent application DE 10 2013 211 965.8 the disclosure of which is hereby incorporated into this application.

### FIELD OF THE INVENTION

The invention relates to a receiving system for a safety vest unit in a vehicle interior, in particular in a vehicle passenger compartment, said receiving system having a receiving compartment in which at least one safety vest unit is stowed. The invention also relates to a safety vest unit having at least one compactly packed safety vest and also having a packaging that is embodied from a thin flexible fabric that encompasses the at least one safety vest.

### BACKGROUND OF THE INVENTION

A safety vest unit for use in a motor vehicle is generally known. The safety vest unit comprises a safety vest that is embodied from a flexible textile material and is stored folded-up in a foil packaging. The safety vest unit comprises a package volume of 350 cm³ to 400 cm³. The safety vest unit is stowed on a suitable storage surface within the vehicle interior of the motor vehicle. Suitable storage surfaces are storage pockets in the side doors, under the seats or in a storage net in the region of a backrest arrangement of a seat.

### SUMMARY OF THE INVENTION

The object of the invention is to provide a receiving system and a safety vest unit of the type mentioned in the introduction and said receiving system and safety vest unit render it possible to store the safety vest unit in the vehicle interior in a space-saving and secure manner.

The object of the invention is achieved for the receiving system of the type that is mentioned in the introduction by virtue of the fact that fixing means are provided in the receiving compartment for the purpose of securing the safety vest unit. The fixing means preferably function in a mechanical manner. It is also possible to provide fixing means that function in a magnetic or electromagnetic manner and in this case it is necessary to also provide the safety vest unit with a metal coating that functions in a magnetic manner.

In one embodiment of the receiving system, sensor means are provided for detecting the presence of a safety vest unit in the receiving compartment. In most European countries, but also in countries outside Europe, a driver is now required by law to carry at least one safety vest unit in the vehicle interior. It is ensured by means of the sensor means that it is possible to detect whether or not a safety vest unit is carried in the vehicle.

In a further embodiment of the invention, the fixing means comprise a lid that removably closes the receiving compartment. As a consequence, it is ensured that the safety vest unit is secured in the receiving compartment in a particularly efficient manner. Furthermore, the receiving compartment is closed by means of the lid in a manner that is resistant to contamination and is visually appealing.

In a further embodiment of the invention, the receiving compartment is arranged in an access region of a front seat or a rear seat of the vehicle interior, in particular in a roof region or in a door region or in the region of a centre console or an instrument panel or in, on or under a seat or backrest region or in the region of an armrest arrangement or in a floor region in front of or under the front and/or rear seats. The receiving compartment is provided at a site where an occupant of the vehicle can access said receiving compartment from his seat without said occupant having to strain himself. The access region therefore represents at least essentially an arm length region of an occupant of the vehicle.

In a further embodiment of the invention, the receiving compartment is arranged within the vehicle interior in a stationary manner or in such a manner that said receiving compartment can be displaced. If the receiving compartment is arranged in the vehicle interior in such a manner that said receiving compartment can be displaced, said receiving compartment can be displaced according to a type of drawer or according to a pivoting door or in a similar manner between a closed position and a released position.

In a further embodiment, the receiving compartment is provided in a region of a belt lock of a safety belt, in particular on a belt buckle or a belt buckle receiving device. The belt buckle is for this purpose provided with a receiving shoe that houses the receiving compartment and the safety vest unit. Upon detaching the safety belt, the belt buckle moves into the position in which it rolls up the safety belt together with the receiving shoe.

In a further embodiment of the invention, releasing means are provided for detaching the fixing means and said releasing means can be actuated by a control unit. The control unit can be activated manually. Alternatively or in complement thereto, the control unit can be activated by means of incidents that occur whilst the vehicle is travelling.

In a further embodiment of the invention, providing means are allocated to the releasing means and said providing means transfer the safety vest unit into an access position for an occupant of the vehicle. The fixing means are not only detached as required by means of the providing means but rather the safety vest unit is also transferred into an access position in which an occupant of the vehicle can reach the safety vest unit in a particularly simple manner. This is to ensure that, in the case of an unexpected incident whilst the vehicle is travelling, the occupant of the vehicle does not leave the vehicle without a safety vest unit.

In a further embodiment of the invention, the control unit is allocated means for detecting an emergency situation, a driving function malfunction or an extraordinary change in a driving condition, wherein the control unit controls the releasing means and/or the providing means in dependence upon detected data signals from the means for detecting an emergency situation, a driving function malfunction or an extraordinary change in a driving condition. As a consequence, in the case of an emergency, during a driving function malfunction or an extraordinary change in a driving condition, the safety vest unit can be automatically brought into an access position in which the occupant of the vehicle can access the safety vest unit in a simple manner as soon as he leaves the vehicle. This automatism has considerable advantages particularly in stressful situations for the occupants of the vehicle since it is not necessary for the occupant of the vehicle to give a thought to the fact that he requires the safety vest unit and where the safety vest unit could possibly be in the vehicle. In fact, for these cases the safety vest unit quasi forcibly imposes on the vehicle occupant. Suitable incidents can be an actuation of the warning light system, an intense vehicle deceleration or acceleration by means of a front or rear collision, the airbags being triggered, the seat belt tensioner being triggered, a drop in tyre pressure, an actuation of the emergency assistants, an intense tilting of the vehicle, in the case of a cabriolet an activation of an antiroll bar, extraordinary driving conditions of the running gear (in particular skidding of the vehicle) and also extraordinary characteristics of the vehicle motor such as detection of a malfunction of the engine control unit, a drop in voltage of the vehicle battery, an increase in temperature of the cooling water or an insufficient level of oil.

In a further embodiment of the invention, visual indicating means are allocated to the receiving compartment and said indicating means indicate the presence or lack of a safety vest unit in the receiving compartment. The visual indicating means can be active lighting means or, passive reflective means that signal where the safety vest unit is stowed and/or the lack of a safety vest unit. The visual indicating means can be directly allocated to the receiving compartment. Alternatively, the visual indicating means can also be arranged in the visual range of a driver of the motor vehicle, in particular in the region of an instrument panel. In order to be able to detect the presence of a safety vest unit, the safety vest unit can be provided in the region of an outer face or an inner face of the vacuum packaging with an RFID tag that is detected by suitable electronic sensor means in the region of the receiving compartment.

For the safety vest unit of the type mentioned in the introduction, the object of the invention is achieved by virtue of the fact that the packaging that encompasses the safety vest is embodied as vacuum packaging. As a consequence, the safety vest unit in the finished packed state of the safety vest is embodied in an extremely compact and dimensionally stable manner since the safety vest is compressed to the smallest possible package measurement and is fixed in said compressed state by means of the vacuum packaging. As a result of the vacuum packaging, the safety vest unit comprises a pocket format of approximately the size of a pack of cards. As a result of the vacuum packaging, the safety vest unit assumes the form of a largely dimensionally stable, easily manageable body, in particular in a cuboid form. Owing to the very compact and compressed configuration of the package, the safety vest unit has a quite small sustained combustibility such that a specific chemical treatment of the safety vest material can be omitted. In fact, the safety vest material per se would exhibit such a high sustained combustion rate that, without the vacuum package, the safety criteria of fire resistance in a vehicle interior would not be ensured.

In one embodiment of the invention, the fabric of the vacuum packaging is resistant to UV radiation. A resistance in particular to UV-A radiation is provided since UV-A can also penetrate the window panes of the motor vehicle. A longer service life of the vacuum packaging of the safety vest unit is ensured as a result of the resistance to UV radiation. It is preferred that the fabric of the vacuum packaging is also designed in a flame retardant manner. Furthermore, the fabric of the vacuum packaging is stable relative to its material characteristics in a temperature range between −50° C. and +80° C.

In a further embodiment of the invention, the fabric is embodied in a water-repellent manner at least in the region of an exterior side of the vacuum packaging. A moisture resistance of this type ensures that the vacuum packaging or the material of the safety vest that is located in the vacuum packaging is not damaged by moisture.

In a further embodiment of the invention, a package volume of the vacuum packaging that encompasses the safety vest is greater than 50 cm³ and smaller than 100 cm³. As a consequence, a particularly compact management and storage of the safety vest unit in the motor vehicle is ensured. The safety vest unit preferably comprises a cuboid outer contour.

### BRIEF DESCRIPTION OF THE DRAWINGS

Further advantages and features of the invention are evident in the claims and also the description hereinunder of a preferred exemplary embodiment of the invention that is illustrated with reference to the drawings.

FIG. 1 schematically illustrates a vehicle interior of a passenger car having an embodiment of a receiving system in accordance with the invention for at least one safety vest unit,

FIGS. 2A to 2C schematically illustrate the storage arrangement of an embodiment of a safety vest unit in accordance with the invention in the region of a side door,

FIGS. 3A and 3B illustrate the stowing of at least one safety vest unit in a roof region of the vehicle interior, and

FIGS. 4A to 4C illustrate the storage arrangement of multiple safety vest units in the region of a centre console of the vehicle interior.

### DETAILED DESCRIPTION

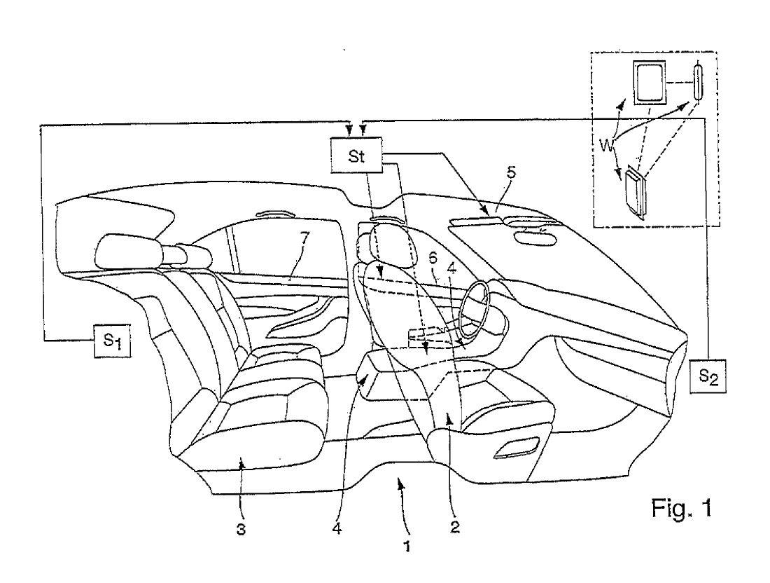

A vehicle interior 1 for a passenger car in accordance with FIG. 1 comprises two driver-side and passenger-side front seats 2 and also rear seats 3 in the form of a rear seat bank. A centre console 4 extends between the two front seats 2 to a rear region of the vehicle interior 1. Handles are provided in a roof region 5 of the vehicle interior above front side doors 6 and rear side doors 7 in the roof region. Above a front windscreen, the roof region 5 is provided with sun visors and also with a rear view mirror console in which light functions for an interior lighting system are also included.

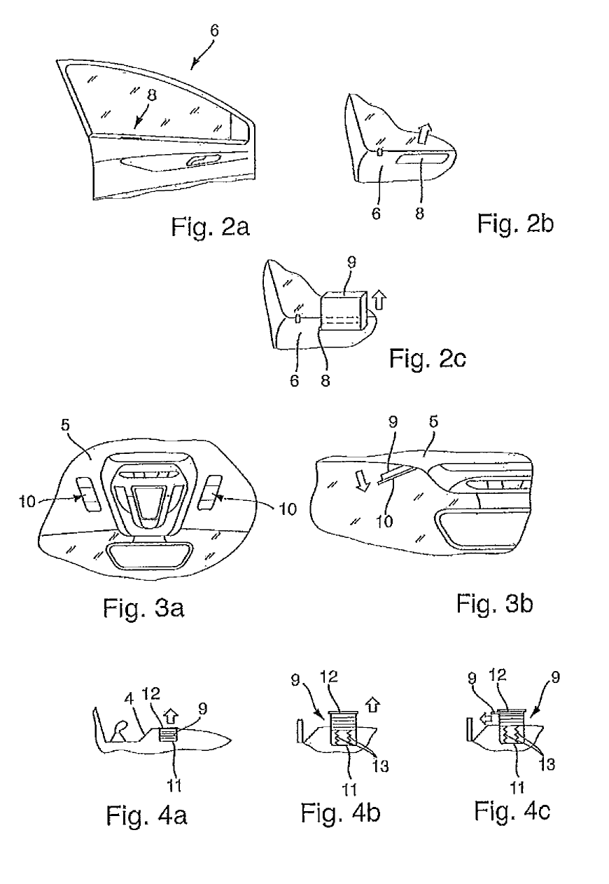

As is described hereinunder with reference to FIGS. 2A to 4C, different storage possibilities for storing one or multiple safety vest units W are provided in the vehicle interior 1. A safety vest unit W of this type comprises a safety vest that is produced from a textile material or a foil material and said safety vest is compactly folded and/or rolled together in its stowed position. The safety vest is surrounded by a vacuum packaging that is embodied by means of a flexible, foil-type fabric. The foil-type flexible fabric entirely encompasses the safety vest in its compactly packed stowed state and closes the safety vest in an airtight manner. For this purpose, the vacuum packaging has a circumferential seam embodied from the flexible fabric that is weldable and is fused in the region of the seam in a circumferential manner. In the case of applying the vacuum packaging, a vacuum is applied so that the air within the compactly packed safety vest is extracted and subsequently the fabric of the vacuum packaging is fused in a circumferential sealed manner. As a consequence, the vacuum within the stowing space for the safety vest is maintained and secured. As is evident in the upper right-hand region with reference to FIG. 1, the safety vest unit W having a safety vest and encompassing vacuum packaging comprises a cuboid form whose package volume preferably lies between 60 cm³ and 80 cm³. A preferred pack measurement of the safety vest unit W comprises a thickness of 14 or 15 mm, a width of 53 or 54 mm and a length of 88 to 92 mm.

The safety vest unit W is embodied as a disposable product. After opening the vacuum packaging, the safety vest can henceforth no longer be stowed in the vacuum packaging.

Stowing spaces in the form of receiving compartments can be provided at different positions within the vehicle interior for storing safety vest units W in the vehicle interior and said stowing spaces are tailored to suit the volume of the safety vest unit or units that are to be received. A sensor means for detecting the presence or rather the lack of a safety vest unit can be integrated in the receiving compartment. A sensor means of this type can electromagnetically detect the presence or lack of a safety vest unit W by way of RFID tags or also by way of weight sensor technology or similar means. The lack of a safety vest unit W can be indicated as a result of the detection by means of the sensor means as a light, sound or radio signal. The signal can be output in particular during the process of starting or stopping a motor vehicle. A visual signal can be provided in the region of the instrument panel. It is also possible to transmit a corresponding warning signal by way of Bluetooth or WIFI to mobile electronic devices such as smartphones, laptops or similar. Alternatively, it is possible to detect the presence or rather the lack of a safety vest unit W by way of a vehicle diagnostic plug.

A corresponding safety vest unit W can be stowed in a receiving compartment within the vehicle interior 1. An arrangement for stowing safety vest units W, 9 in the region of a front side door 6 (FIG. 2A to 2C), in the region of a rear view mirror console of a roof region 5, said rear view mirror console also being described as a roof console (FIG. 3A and 3B), or in the region of a centre console 4 (FIG. 4A to 4C) is explained with reference to FIG. 2A to 4C.

In the case of all variants, the respective receiving compartment for the safety vest unit 9, W is closed by means of a fixing means in the form of a lid 8, 10, 12. In the case of the embodiment in accordance with FIGS. 2A to 2C, the receiving compartment is integrated on the inner side of the side door 6 adjacent to a door closing button in an upper face of a door lining and is closed by means of a lid 8 that is pivotably mounted. Providing means in the form of a pressure spring arrangement are integrated in the receiving compartment, said pressure spring arrangement is not illustrated in detail and causes the safety vest unit 9 to be pushed upwards after the lid 8 is opened. As a consequence, in accordance with FIG. 2C, a person sitting in the driver's seat can reach the safety vest unit 9 in a simple manner as soon as the lid 8 is opened and the pressure spring arrangement has pushed the safety vest unit 9 upwards out of the receiving compartment.

In the case of the embodiment according to FIGS. 3A and 3B, two receiving compartments are provided on the two sides of the roof console of the roof region 5 and a safety vest unit 9 is stored in each receiving compartment. When the safety vest unit 9 is not required and is in the stowed position, the respective lid 10 is in its position in which it closes the receiving compartment and fixes the safety vest unit 9 within the receiving compartment. As soon as the lid 10 is opened, said lid pivots inclined downwards in accordance with FIG. 3B, whereby the safety vest unit 9 that lies on the inner side of the lid 10 can be grasped and can be removed from the receiving compartment.

In the case of the embodiment according to FIGS. 4A to 4C, multiple safety vest units 9 are stacked one on top of the other in a receiving compartment 11, wherein the receiving compartment 11 is closed by means of a lid 12 when the safety vest units 9 are in the stowed position. Providing means for the safety vest units 9 are also provided in the case of the embodiment according to FIGS. 4A to 4C and said providing means are designed according to a type of a telescopic extendible drawer with the aid of a pressure spring arrangement 13. The drawer is displaced upwards as required whereby underneath the lid 12 that is likewise simultaneously displaced upwards in each case a safety vest unit 9 can be withdrawn towards the side (FIG. 4C).

It is possible to manually detach the lid by means of a mechanical releasing device. In the case of the exemplary embodiments that are illustrated with reference to FIGS. 1 to 4C, the process of detaching and opening the lids 8, 10, 12 is performed by means of an electronic control unit St that performs a controlling process corresponding to control arrangements that are used as releasing means for the lids 8, 10, 12 in dependence upon sensor signals from sensor units S₁, S₂. The sensor units S₁ and S₂ detect an emergency situation, a driving function malfunction or an extraordinary change in a driving condition. For this purpose, a corresponding sensor unit S₁, S₂ can be allocated to an engine control unit, an electronic running gear control, a tilt sensor arrangement, an acceleration sensor arrangement, and similar in order to detect malfunctions in the engine, a tilting of the vehicle or a rolling of the vehicle or a vehicle collision or similar.

In the case of further embodiments (not illustrated) of the invention, a receiving compartment for a safety vest unit is provided as a receiving area in the region of a sun visor or at another position in the passenger compartment and said receiving compartment is provided with fixing means in the form of a Velcro fastener or an elastic band. In the bottom area the receiving compartment can be integrated in a floor mat or in a fitted carpet that is fixed to the body floor. The floor mat can be cut out in the region of the receiving compartment in order to make the position of the safety vest visible. It is also possible in accordance with a further embodiment to integrate the receiving compartment in a breakdown kit of the vehicle passenger compartment which kit can be designed in particular as a tear-open package set.

1. Receiving system for a safety vest unit (9, W) in a vehicle interior (1), in particular in a vehicle passenger compartment, said receiving system having a receiving compartment (11) in which at least one safety vest unit (9, W) is stowed, characterized in that fixing means (8, 10, 12) are provided for securing the safety vest unit (9, W) in the receiving compartment (11).

2. Receiving system according to claim 1, characterized in that sensor means are provided for detecting the presence of a safety vest unit (9, W) in the receiving compartment (11).

3. Receiving system according to claim 1, characterized in that the fixing means comprise a lid (8, 10, 12) that removably closes the receiving compartment (11).

4. Receiving system according to claim 1, characterized in that the receiving compartment (11) is arranged in an access region of a front seat (2) or a rear seat (3) of the vehicle interior (1), in particular in a roof region (5) or in a door region (6, 7) or in the region of a centre console (4) or an instrument panel or in, on or under a seat or backrest region or in the region of an armrest arrangement or in a floor region in front of or under the front and/or rear seats.

5. Receiving system according to claim 1, characterized in that the receiving compartment is arranged in the vehicle interior (1) in a stationary manner or in such a manner that said receiving compartment can be displaced.

6. Receiving system according to claim 5, characterized in that the receiving compartment is provided in a region of a belt lock of a safety belt, in particular on a belt buckle or a belt lock receiving device.

7. Receiving system according to claim 1, characterized in that releasing means are provided for the purpose of detaching the fixing means (8, 10, 12) and said releasing means can be actuated by a control unit (St).

8. Receiving system according to claim 7, characterized in that the releasing means are allocated providing means that transfer the safety vest unit (9, W) into an access position for an occupant of the vehicle in dependence upon the releasing means being detached.

9. Receiving system according to any one of claims 1 to 8, characterized in that the control unit (St) is allocated means (S₁, S₂) for detecting an emergency situation, a driving function malfunction or an extraordinary change in a driving condition, wherein the control unit (St) controls the releasing means and/or the providing means in dependence upon detected data signals from the means (S₁, S₂) for detecting an emergency situation, a driving function malfunction or an extraordinary change in a driving condition.

10. Receiving system according to claim 1, characterized in that the receiving compartment is allocated visual indicating means that indicate the presence and/or the lack of a safety vest unit (9, W) in the receiving compartment.

11. Safety vest unit having at least one compactly packed safety vest and also having a packaging that is embodied from a thin flexible fabric that encompasses the at least one safety vest, characterized in that the packaging that encompasses the safety vest is embodied as vacuum packaging.

12. Safety vest unit according to claim 11, characterized in that the fabric of the vacuum packaging is resistant to UV radiation.

13. Safety vest unit according to claim 11 or 12, characterized in that the fabric is designed to be water repellent at least in the region of an outer side of the vacuum packaging.

14. Safety vest unit according to any one of claims 11 to 13, characterized in that a package volume of the vacuum packaging that encompasses the safety vest is greater than 50 cm³ and smaller than 100 cm³.
